(19) United States
(12) Patent Application Publication
(10) Pub. No.: US 2024/0210144 A1
(43) Pub. Date: Jun. 27, 2024

(54) BULLET-PROOF AND STAB-PROOF MATERIAL

(71) Applicant: NANTONG UNIVERSITY, Nantong, Jiangsu (CN)

(72) Inventors: Hongxia CHEN, Nantong, Jiangsu (CN); Haijian CAO, Nantong, Jiangsu (CN); Xuefeng YAN, Nantong, Jiangsu (CN); Yan MA, Nantong, Jiangsu (CN); Xiaomei HUANG, Nantong, Jiangsu (CN)

(73) Assignee: NANTONG UNIVERSITY, Nantong, Jiangsu (CN)

(21) Appl. No.: 17/910,878

(22) PCT Filed: Dec. 16, 2021
(86) PCT No.: PCT/CN2021/138837

§ 371 Date: Sep. 12, 2022

(30) Foreign Application Priority Data
Nov. 23, 2021 (CN) 202111395807.6

(51) Int. Cl. F41H 5/04; B32B 5/02; B32B 5/12

(52) U.S. Cl. CPC F41H 5/0478; B32B 5/024; B32B 5/12; B32B 2250/20; B32B 2260/023; B32B 2260/046; B32B 2262/0253; B32B 2262/0269; B32B 2307/558; B32B 2307/56; B32B 2307/581; B32B 2307/72; B32B 2307/7376; B32B 2571/02

(57) ABSTRACT

Provided is a bullet-proof and stab-proof material. The bullet-proof and stab-proof material includes an impact-resistant layer and a cutting-resistant, bullet-proof and energy-absorbing layer, where the impact-resistant layer is one or more Kevlar fiber-based unidirectional (UD) sheets; and the cutting-resistant, bullet-proof and energy-absorbing layer is formed by stacking a plurality of the Kevlar fiber-based UD sheets and/or a plurality of ultra-high-molecular-weight polyethylene (UHMWPE) fiber-based UD sheets, or by stacking a plurality of Kevlar/UHMWPE hybrid fiber-based UD sheets.

### CROSS REFERENCE TO RELATED APPLICATION

This patent application claims the benefit and priority of Chinese Patent Application No. 202111395807.6, entitled “Bullet-proof and stab-proof material” filed on Nov. 23, 2021, the disclosure of which is incorporated by reference herein in its entirety as part of the present disclosure.

### TECHNICAL FIELD

The present disclosure belongs to the technical field of protective materials, and in particular relates to a bullet-proof and stab-proof material.

### BACKGROUND ART

The research and development, and manufacture of protective clothing are closely related to the development of various weapons and the advancement of equipment levels. Bullet-proof vests are initially mainly made of hard bullet-proof materials such as special steel, aluminum alloys and other metals, with certain bullet-proof properties. However, these bullet-proof vests are heavy and uncomfortable to wear, which causes great restrictions on human activities, and are prone to secondary debris. To improve the wearing comfort of bullet-proof vests, soft bullet-proof materials are produced. The soft bullet-proof material has light weight, soft texture, desirable fit, and better concealment when being worn inside. In terms of bullet-proof capability, the existing soft bullet-proof materials (generally stacked by a plurality of unidirectional (UD) sheets with an areal density of about 160 g/m²) can generally resist bullets from pistols and submachine guns 5 m away. However, these soft bullet-proof materials have a high backface signature, a to-be-improved bullet-proof property, and no stab-proof effect. Therefore, it has become an urgent problem to be solved to improve bullet-proof and stab-proof properties of the soft bulletproof materials.

### SUMMARY

An object of the present disclosure is to provide a material with excellent bullet-proof and stab-proof effects.

To achieve the above object, the present disclosure provides the following technical solutions.

The present disclosure provides a bullet-proof and stab-proof material, including an impact-resistant layer and a cutting-resistant, bullet-proof and energy-absorbing layer that are arranged in sequence, where
the impact-resistant layer is one or more Kevlar fiber-based unidirectional (UD) sheets;
the cutting-resistant, bullet-proof and energy-absorbing layer is formed by stacking a plurality of the Kevlar fiber-based UD sheets and/or a plurality of ultra-high-molecular-weight polyethylene (UHMWPE) fiber-based UD sheets, or by stacking a plurality of Kevlar/UHMWPE hybrid fiber-based UD sheets; and
each of the Kevlar/UHMWPE hybrid fiber-based UD sheets is prepared by a process comprising hot pressing and compounding a plurality of layers of hybrid fiber-based UD single sheets, wherein each of the hybrid fiber-based UD single sheets is prepared from a Kevlar fiber, a UHMWPE fiber, and a thermoplastic resin according to a forming method of a UD fabric; or
each of the Kevlar/UHMWPE hybrid fiber-based UD sheets is prepared by a process comprising hot pressing and compounding a plurality of layers of Kevlar fiber-based UD single sheets and a plurality of layers of UHMWPE fiber-based UD single sheets that are alternately arranged.

In some embodiments, the bullet-proof and stab-proof material further includes an anti-backface signature layer stacked on an other side of the cutting-resistant, bullet-proof and energy-absorbing layer, where the anti-backface signature layer is one or more the Kevlar fiber-based UD sheets, one or more the UHMWPE fiber-based UD sheets, one or more Kevlar fiber-woven composite sheets, or one or more UHMWPE fiber-woven composite sheets.

In some embodiments, each of the Kevlar fiber-based UD sheets is prepared by a process comprising hot pressing and compounding six or eight layers of the Kevlar fiber-based UD single sheets, in which two adjacent layers of the Kevlar fiber-based UD single sheets are orthogonally arranged; and each of the Kevlar fiber-based UD sheets has an areal density of 180 g/m² to 400 g/m².

In some embodiments, each of the UHMWPE fiber-based UD sheets is prepared by a process comprising hot pressing and compounding six or eight layers of the UHMWPE fiber-based UD single sheets, in which two adjacent layers of the UHMWPE fiber-based UD single sheets are orthogonally arranged; and each of the UHMWPE fiber-based UD sheets has an areal density of 120 g/m² to 320 g/m².

In some embodiments, each of the Kevlar fiber-woven composite sheets has an areal density of 200 g/m² to 350 g/m²; and each of the UHMWPE fiber-woven composite sheets has an areal density of 150 g/m² to 300 g/m².

In some embodiments, in the impact-resistant layer, each Kevlar fiber-based UD sheet is prepared by a process comprising hot pressing and compounding six or eight layers of the Kevlar fiber-based UD single sheets, in which two adjacent layers of the Kevlar fiber-based UD single sheets are orthogonally arranged; and each Kevlar fiber-based UD sheet has an areal density of 180 g/m² to 400 g/m².

In some embodiments, in the cutting-resistant, bullet-proof and energy-absorbing layer, each Kevlar fiber-based UD sheet is prepared by a process comprising hot pressing and compounding four to eight layers of the Kevlar fiber-based UD single sheets, and has an areal density of 120 g/m² to 200 g/m².

In some embodiments, each of the UHMWPE fiber-based UD sheet is prepared by a process comprising hot pressing and compounding four to eight layers of the UHMWPE fiber-based UD single sheets, and has an areal density of 80 g/m² to 160 g/m².

In some embodiments, each of the Kevlar/UHMWPE hybrid fiber-based UD sheet is prepared by a process comprising hot pressing and compounding four to eight layers of the hybrid fiber-based UD single sheets, and has an areal density of 100 g/m² to 180 g/m².

In some embodiments, each of the Kevlar/UHMWPE hybrid fiber-based UD sheet is prepared by a process comprising hot pressing and compounding two to four layers of the Kevlar fiber-based UD single sheets, in which the two to four layers of the UHMWPE fiber-based UD single sheets are alternately arranged; and each of the Kevlar/UHMWPE hybrid fiber-based UD sheets has an areal density of 100 g/m² to 180 g/m².

The present disclosure provides a bullet-proof and stab-proof material, including an impact-resistant layer and a cutting-resistant, bullet-proof and energy-absorbing layer that are arranged in sequence, where the impact-resistant layer is one or more Kevlar fiber-based UD sheets; the cutting-resistant, bullet-proof and energy-absorbing layer is formed by stacking a plurality of the Kevlar fiber-based UD sheets and/or a plurality of the UHMWPE fiber-based UD sheets, or by stacking a plurality of the Kevlar/UHMWPE hybrid fiber-based UD sheets; and each of the Kevlar/UHMWPE hybrid fiber-based UD sheet is prepared by a process comprising hot pressing and compounding a plurality of layers of the hybrid fiber-based UD single sheets, wherein each hybrid fiber-based UD single sheet is prepared from a Kevlar fiber, a UHMWPE fiber, and a thermoplastic resin according to a forming method of a UD fabric; or each of the Kevlar/UHMWPE hybrid fiber-based UD sheets is prepared by a process comprising hot pressing and compounding a plurality of layers of the Kevlar fiber-based UD single sheets and a plurality of layers of the UHMWPE fiber-based UD single sheets that are alternately arranged. The bullet-proof and stab-proof material of the present disclosure includes an impact-resistant layer and a cutting-resistant, bullet-proof and energy-absorbing layer, where the impact-resistant layer is one or more Kevlar fiber-based UD sheets, making it possible to resist initial cutting of a cutting tool and initial impact of shrapnel; and the cutting-resistant, bullet-proof and energy-absorbing layer is formed by stacking a plurality of the Kevlar fiber-based UD sheets and/or a plurality of the UHMWPE fiber-based UD sheets, or by stacking a plurality of the Kevlar/UHMWPE hybrid fiber-based UD sheets. The Kevlar fiber and the UHMWPE fiber endow the bullet-proof and stab-proof material with cutting-resistant, bullet-proof and energy-absorbing functions, thereby reducing the backface signature and further enhancing a bullet-proof and stab-proof effect. The experimental results show that the bullet-proof and stab-proof material of the present disclosure has a total areal density of 4.0 kg/m² to 8.5 kg/m², meeting bullet-proof requirements of GA Level 2 (average backface signature of less than or equal to 25 mm), GA Level 3 (average backface signature of less than or equal to 25 mm), NIJ Level IIA (average backface signature of less than or equal to 35 mm), NIJ Level II (average backface signature of less than or equal to 35 mm), and NIJ Level IIIA (average backface signature of less than or equal to 32 mm), and a stab-proof requirement of NIJ Level 2.

### DETAILED DESCRIPTION OF THE EMBODIMENTS

The present disclosure provides a bullet-proof and stab-proof material, including an impact-resistant layer and a cutting-resistant, bullet-proof and energy-absorbing layer that are arranged in sequence, where
the impact-resistant layer is one or more Kevlar fiber-based unidirectional (UD) sheets;
the cutting-resistant, bullet-proof and energy-absorbing layer is formed by stacking a plurality of the Kevlar fiber-based UD sheets and/or a plurality of ultra-high-molecular-weight polyethylene (UHMWPE) fiber-based UD sheets, or by stacking a plurality of Kevlar/UHMWPE hybrid fiber-based UD sheets; and
each of the Kevlar/UHMWPE hybrid fiber-based UD sheets is prepared by a process comprising hot pressing and compounding a plurality of layers of hybrid fiber-based UD single sheets, wherein each hybrid fiber-based UD single sheet is prepared from a Kevlar fiber, a UHMWPE fiber, and a thermoplastic resin according to a forming method of a UD fabric; or
each of the Kevlar/UHMWPE hybrid fiber-based UD sheet is prepared by a process comprising hot pressing and compounding a plurality of layers of Kevlar fiber-based UD single sheets and a plurality of layers of UHMWPE fiber-based UD single sheets that are alternately arranged.

In the present disclosure, the bullet-proof and stab-proof material includes the impact-resistant layer. The impact-resistant layer makes it possible to resist initial cutting of a cutting tool and initial impact of shrapnel.

In the present disclosure, the impact-resistant layer is one or more Kevlar fiber-based UD sheets. In some embodiments, each of the Kevlar fiber-based UD sheets is prepared by a process comprising hot pressing and compounding six or eight layers of the Kevlar fiber-based UD single sheets, in which two adjacent layers of the Kevlar fiber-based UD single sheet are orthogonally arranged. The impact-resistant layer is one or more Kevlar fiber-based UD sheets, which makes it possible to resist the initial cutting of the cutting tool and the initial impact of the shrapnel. The ability to resist the initial cutting of the cutting tool and the initial impact of the shrapnel could be further improved by limiting the specific number of layers of the Kevlar fiber-based UD sheets, thereby further enhancing a bullet-proof and stab-proof effect.

In some embodiments, in the Kevlar fiber-based UD single sheet, the Kevlar fiber has a linear density of 200 D to 800 D, and a monofilament strength of 25 cN/dtex to 40 cN/dtex. There are no special limitations on the source of the Kevlar fiber-based UD single sheet, and commercially-available products or a product prepared by a well-known process well known to those skilled in the art may be used.

In some embodiments, the Kevlar fiber-based UD single sheet has an areal density of 30 g/m² to 50 g/m², and a thickness of 0.05 mm to 0.15 mm.

In some embodiments, the hot pressing and compounding is conducted at a temperature of 120° C. to 140° C.; the hot pressing and compounding is conducted at a pressure of 20 MPa to 40 MPa; and the hot pressing and compounding is conducted for 20 min to 60 min. Between the two adjacent Kevlar fiber-based UD single sheets, a further improved bonding strength could be achieved by controlling process parameters of the hot pressing and and compounding to the above range.

In some embodiments, the impact-resistant layer contains one to five of the Kevlar fiber-based UD sheets. In some embodiments, the two adjacent Kevlar fiber-based UD sheets are orthogonally arranged.

In some embodiments, the Kevlar fiber-based UD sheet has an areal density of 180 g/m² to 400 g/m², more preferably 200 g/m² to 320 g/m². In the present disclosure, by limiting the areal density of the Kevlar fiber-based UD sheet within the above range, the ability of the impact-resistant layer to resist initial cutting of a cutting tool and initial impact of shrapnel could be further improved.

In some embodiments, the impact-resistant layer has a thickness of 0.5 mm to 2.5 mm. In the present disclosure, by controlling the thickness of the impact-resistant layer within the above range, the ability of the impact-resistant layer to resist initial cutting of a cutting tool and initial impact of shrapnel could be further improved.

In the present disclosure, the bullet-proof and stab-proof material further includes a cutting-resistant, bullet-proof and energy-absorbing layer adjacent to the impact-resistant layer. The cutting-resistant, bullet-proof and energy-absorbing layer could endow the material with functions of cutting-resistant, bullet-proof and energy-absorbing. There are no special limitations on the combination method of the impact-resistant layer and the cutting-resistant, bullet-proof and energy-absorbing layer, and stacking methods well-known to those skilled in the art may be used.

In the present disclosure, the cutting-resistant, bullet-proof and energy-absorbing layer is formed by stacking a plurality of the Kevlar fiber-based UD sheets and/or a plurality of the UHMWPE fiber-based UD sheets, or by stacking a plurality of the Kevlar/UHMWPE hybrid fiber-based UD sheets.

In an embodiment of the present disclosure, the cutting-resistant, bullet-proof and energy-absorbing layer is formed by stacking a plurality of the Kevlar fiber-based UD sheets and/or a plurality of the UHMWPE fiber-based UD sheets. In some embodiments, under the condition that the cutting-resistant, bullet-proof and energy-absorbing layer is formed by stacking a plurality of the Kevlar fiber-based UD sheets, the two adjacent Kevlar fiber-based UD sheets are arranged orthogonally. In some embodiments, under the condition that the cutting-resistant, bullet-proof and energy-absorbing layer is formed by stacking a plurality of the UHMWPE fiber-based UD sheets, the two adjacent UHMWPE fiber-based UD sheets are arranged orthogonally. In some embodiments, under the condition that the cutting-resistant, bullet-proof and energy-absorbing layer is formed by stacking a plurality of the Kevlar fiber-based UD sheets and a plurality of the UHMWPE fiber-based UD sheets, and the two adjacent UD sheets are arranged orthogonally.

In some embodiments, the Kevlar fiber-based UD sheet is prepared by a process comprising hot pressing and compounding four to eight layers of the Kevlar fiber-based UD single sheets. In some embodiments, the two adjacent Kevlar fiber-based UD single sheets are arranged orthogonally. In some embodiments, the Kevlar fiber-based UD single sheet has an areal density of 30 g/m² to 50 g/m², and a thickness of 0.05 mm to 0.15 mm. In some embodiments, the hot pressing and compounding is conducted at a temperature of 120° C. to 140° C.; the hot pressing and compounding is conducted at a pressure of 20 MPa to 40 MPa; and the hot pressing and compounding is conducted for 20 min to 60 min. There are no special limitations on the source of the Kevlar fiber-based UD single sheet, and commercially-available products or a product prepared by a well-known preparation process well known to those skilled in the art may be used. Between the two adjacent Kevlar fiber-based UD single sheets, a further improved bonding strength could be achieved by controlling process parameters of the hot pressing and compounding to the above range.

In some embodiments, composition of the Kevlar fiber-based UD single sheet is the same as that of the Kevlar fiber-based UD single sheet in the aforementioned impact-resistant layer, which will not be repeated here.

In some embodiments, the Kevlar fiber-based UD sheet has an areal density of 120 g/m² to 200 g/m², preferably 150 g/m² to 200 g/m². In some embodiments, there are 10 to 80, preferably 20 to 50, and more preferably 22 to 32 of the Kevlar fiber-based UD sheets. In the present disclosure, by controlling the areal density and number of the Kevlar fiber-based UD sheet to the above range, the ability of the bullet-proof and stab-proof material in cutting-resistant, bullet-proof and energy-absorbing could be further improved.

In some embodiments, the UHMWPE fiber-based UD sheet is prepared by a process comprising hot pressing and compounding four to eight layers of the UHMWPE fiber-based UD single sheets. In some embodiments, the UHMWPE fiber-based UD single sheet has an areal density of 20 g/m² to 40 g/m². In some embodiments, the hot pressing and compounding is conducted at a temperature of 120° C. to 140° C.; in some embodiments, the hot pressing and compounding is conducted at a pressure of 20 MPa to 40 MPa; and in some embodiments, the hot pressing and compounding is conducted for 20 min to 60 min. There are no special limitations on the source of the UHMWPE fiber-based UD single sheet, and commercially-available products or a product prepared by a well-known preparation process well known to those skilled in the art may be used. A bonding strength between the UHMWPE fiber-based UD single sheets could be further improved by controlling process parameters of the hot pressing and compounding within the above range.

In some embodiments, in the UHMWPE fiber-based UD single sheet, the UHMWPE fiber has a linear density of 200 D to 800 D, preferably 400 D to 600 D. In some embodiments, the UHMWPE fiber has a monofilament strength of 35 cN/dtex to 50 cN/dtex. There are no special limitations on the source of the UHMWPE fiber-based UD single sheet, and commercially-available products well known to those skilled in the art may be used.

In some embodiments, the UHMWPE fiber-based UD sheet has an areal density of 80 g/m² to 160 g/m², preferably 100 g/m² to 150 g/m². In some embodiments, there are 0 to 40, preferably 20 to 30, and more preferably 21 to 25 of the UHMWPE fiber-based UD sheets. In the present disclosure, by controlling the areal density and number of sheets of the UHMWPE fiber-based UD sheet to the above range, the ability of the bullet-proof and stab-proof material in cutting-resistant, as well as absorbing and dissipating of bullet kinetic energy could be further improved.

In some embodiments, under the condition that the cutting-resistant, bullet-proof and energy-absorbing layer is formed by stacking a plurality of the Kevlar fiber-based UD sheets and a plurality of the UHMWPE fiber-based UD sheets, the Kevlar fiber-based UD sheets are stacked under the impact-resistant layer, followed by stacking the UHMWPE fiber-based UD sheets.

In another embodiment of the present disclosure, the cutting-resistant, bullet-proof and energy-absorbing layer is formed by stacking a plurality of Kevlar/UHMWPE hybrid fiber-based UD sheets.

In some embodiments, there are 20 to 80, preferably 30 to 50 of the Kevlar/UHMWPE hybrid fiber-based UD sheets; in some embodiments, each Kevlar/UHMWPE hybrid fiber-based UD sheet has an areal density of 100 g/m² to 190 g/m², preferably 150 g/m² to 160 g/m². In the present disclosure, by controlling the structure, areal density and number of sheets of the Kevlar/UHMWPE hybrid fiber-based UD sheet to the above range, the ability of the bullet-proof and stab-proof material in cutting-resistant, as well as absorbing and dissipating of bullet kinetic energy could be further improved.

In the present disclosure, the Kevlar/UHMWPE hybrid fiber-based UD sheet is prepared by a process comprising hot pressing and compounding a plurality of layers of the hybrid fiber-based UD single sheets, or by conducting hot pressing on a plurality of layers of the Kevlar fiber-based UD single sheets and a plurality of layers of the UHMWPE fiber-based UD single sheets.

In some embodiments, under the condition that the Kevlar/UHMWPE hybrid fiber-based UD sheet is prepared by a process comprising hot pressing and compounding a plurality of layers of the hybrid fiber-based UD single sheets, two adjacent layers of the hybrid fiber-based UD single sheets are arranged orthogonally; the hybrid fiber-based UD single sheet is prepared from the Kevlar fiber, the UHMWPE fiber, and the thermoplastic resin according to the forming method of the UD fabric. In some embodiments, a mass ratio of the Kevlar fiber to the UHMWPE fiber is in the range of 1:1. In some embodiments, the Kevlar fibers and the UHMWPE fibers are arranged alternately. In some embodiments, the thermoplastic resin includes at least one selected from the group consisting of waterborne polyurethane, rubber elastomer, low-density polyethylene (LDPE), and ethyl vinyl acetate copolymer (EVA). In some embodiments, the thermoplastic resin accounts for 20% to 35% of a mass of the hybrid fiber-based UD single sheet. In some embodiments, the hybrid fiber-based UD single sheet has four to eight layers. There are no special limitations on sources of the Kevlar fiber, the UHMWPE fiber, and the thermoplastic resin, and commercially-available products well known to those skilled in the art can be used. There are no special limitations on the operation of the forming method of the UD fabric, and preparation methods well known to those skilled in the art may be used. There are no special limitations on the source of the hybrid fiber-based UD single sheet, and commercially-available products well known to those skilled in the art may be used.

In some embodiments, the hot pressing and compounding is conducted at a temperature of 120° C. to 140° C.; the hot pressing and compounding is conducted at a pressure of 20 MPa to 40 MPa; and the hot pressing and compounding is conducted for 20 min to 60 min. In the present disclosure, the bonding strength between the hybrid fiber-based UD single sheets could be further improved by controlling process parameters of the hot pressing and compounding to the above range.

In some embodiments, under the condition that the Kevlar/UHMWPE hybrid fiber-based UD sheet is prepared by a process comprising hot pressing and compounding a plurality of layers of the Kevlar fiber-based UD single sheets and a plurality of layers of the UHMWPE fiber-based UD single sheets that are alternately arranged, and the Kevlar fiber-based UD single sheet has two to four layers and the UHMWPE fiber-based UD single sheet has two to four layers. In some embodiments, the hot pressing and compounding is conducted at a temperature of 120° C. to 140° C., the hot pressing and compounding is conducted at a pressure of 20 MPa to 40 MPa, and the hot pressing and compounding is conducted for 20 min to 60 min. In the present disclosure, the bonding strength between the UD single sheets could be further improved by controlling process parameters of the hot pressing and compounding to the above range.

In some embodiments, in the Kevlar/UHMWPE hybrid fiber-based UD sheet, two adjacent layers of the UD single sheets are arranged orthogonally.

In some embodiments, a composition of the Kevlar fiber-based UD single sheet is the same as that of the Kevlar fiber-based UD single sheet in the aforementioned impact-resistant layer, which will not be repeated here. In some embodiments, the Kevlar fiber-based UD single sheet has an areal density of 30 g/m² to 50 g/m², and a thickness of 0.05 mm to 0.15 mm. There are no special limitations on the source of the Kevlar fiber-based UD single sheet, and commercially-available products or a product prepared by a well-known preparation process well known to those skilled in the art may be used.

In some embodiments, a composition of the UHMWPE fiber-based UD single sheet is the same as that of the UHMWPE fiber-based UD single sheet in the aforementioned UHMWPE fiber-based UD sheet, which will not be repeated here. The UHMWPE fiber-based UD single sheet has an areal density of 20 g/m² to 40 g/m². There are no special limitations on the source of the UHMWPE fiber-based UD single sheet, and commercially-available products or a product prepared by a well-known preparation process well known to those skilled in the art may be used.

In some embodiments, the cutting-resistant, bullet-proof and energy-absorbing layer has a thickness of 8 mm to 24.5 mm, preferably 8 mm to 20 mm. In the present disclosure, by controlling the thickness of the cutting-resistant, bullet-proof and energy-absorbing layer to the above range, the ability of the bullet-proof and stab-proof material in cutting-resistant, as well as absorbing and dissipating of bullet kinetic energy could be further improved.

In the present disclosure, the bullet-proof and stab-proof material further includes an anti-backface signature layer stacked on an other side of the cutting-resistant, bullet-proof and energy-absorbing layer. The anti-backface signature layer can reduce the backface signature of the bullet-proof and stab-proof material under the action of a tool puncture force or a bullet impact, thereby further improving the bullet-proof and stab-proof effect. There are no special limitations on the combination method of the cutting-resistant, bullet-proof and energy-absorbing layer and the anti-backface signature layer, and stacking methods well-known to those skilled in the art may be used.

In the present invention, the anti-backface signature layer is one or more Kevlar fiber-based UD sheets, one or more UHMWPE fiber-based UD sheets, one or more Kevlar fiber-woven composite sheets, or one or more UHMWPE fiber-woven composite sheets. Under the condition that the anti-backface signature layer is a plurality of the Kevlar fiber-based UD sheets, a plurality of the UHMWPE fiber-based UD sheets, a plurality of the Kevlar fiber-woven composite sheets, or a plurality of the UHMWPE fiber-woven composite sheets, adjacent two of the Kevlar fiber-based UD sheets, the UHMWPE fiber-based UD sheets, the Kevlar fiber-woven composite sheets, or the UHMWPE fiber-woven composite sheets are arranged orthogonally.

In some embodiments, there are one to five of the Kevlar fiber-based UD sheets, there are one to five of the UHMWPE fiber-based UD sheets, there are one to five of the Kevlar fiber-woven composite sheets, and there are one to five of the UHMWPE fiber-woven composite sheets.

In the present disclosure, the Kevlar fiber-based UD sheet is prepared by a process comprising hot pressing and compounding six or eight layers of the Kevlar fiber-based UD single sheets. In some embodiments, in the Kevlar fiber-based UD sheet, two adjacent layers of the Kevlar fiber-based UD single sheets are arranged orthogonally. In some embodiments, the hot pressing and compounding is conducted at a temperature of 120° C. to 140° C., the hot pressing and compounding is conducted at a pressure of 20 MPa to 40 MPa, and the hot pressing and compounding is conducted for 20 min to 60 min. In the present disclosure, the bonding strength between the UD single sheets could be further improved by controlling process parameters of the hot pressing and compounding to the above range.

In some embodiments, the composition of the Kevlar fiber-based UD single sheet is the same as that of the Kevlar fiber-based UD single sheet in the aforementioned impact-resistant layer, which will not be repeated here. In some embodiments, the Kevlar fiber-based UD single sheet has an areal density of 30 g/m² to 50 g/m², and a thickness of 0.05 mm to 0.15 mm. There are no special limitations on a source of the Kevlar fiber-based UD single sheet, and commercially-available products or a product prepared by a well-known preparation process well known to those skilled in the art may be used.

In some embodiments, the Kevlar fiber-based UD sheet has an areal density of 180 g/m² to 400 g/m², preferably 200 g/m² to 300 g/m². In the present disclosure, by controlling the areal density of the Kevlar fiber-based UD sheet within the above range, backface signature of the bullet-proof and stab-proof material under the action of a tool puncture force or a bullet impact could be further reduced, thereby further improving the bullet-proof and stab-proof effect.

In the present disclosure, the UHMWPE fiber-based UD sheet is prepared by a process comprising hot pressing and compounding six or eight layers of the UHMWPE fiber-based UD single sheets. In the UHMWPE fiber-based UD sheet, two adjacent layers of the UHMWPE fiber-based UD single sheets are arranged orthogonally. In some embodiments, the hot pressing and and compounding is conducted at a temperature of 120° C. to 140° C., the hot pressing and and compounding is conducted at a pressure of 20 MPa to 40 MPa, and the hot pressing and and compounding is conducted for 20 min to 60 min. In the present disclosure, the bonding strength between the UD single sheets could be further improved by controlling process parameters of the hot pressing and compounding to the above range.

In some embodiments, the composition of the UHMWPE fiber-based UD single sheet is the same as that of the UHMWPE fiber-based UD single sheet in the aforementioned UHMWPE fiber-based UD sheet, which will not be repeated here. In some embodiments, the UHMWPE fiber-based UD single sheet has an areal density of 20 g/m² to 40 g/m². There are no special limitations on the source of the UHMWPE fiber-based UD single sheet, and commercially-available products or a product prepared by a well-known preparation process well known to those skilled in the art may be used.

In some embodiments, the UHMWPE fiber-based UD sheet has an areal density of 120 g/m² to 320 g/m², preferably 200 g/m² to 300 g/m². In the present disclosure, backface signature of the bullet-proof and stab-proof material under the action of a tool puncture force or a bullet impact could be further improved by controlling the areal density of the UHMWPE fiber-based UD sheet within the above range, thereby further improving the bullet-proof and stab-proof effect.

In some embodiments, the Kevlar fiber-woven composite sheet is prepared by a process comprising:
(1) providing a Kevlar fiber-woven fabric; and
(2) hot pressing and compounding the Kevlar fiber-woven fabric obtained in step (1) with a polyurethane (PU) adhesive film/PU mesh film, to obtain the Kevlar fiber-woven composite sheet.

In the present disclosure, the Kevlar fiber-woven fabric is provided. There are no special limitations on an operation for providing the Kevlar fiber-woven fabric, and operations well known to those skilled in the art may be used.

In the present disclosure, the Kevlar fiber-woven fabric is hot pressed and compounded with the PU adhesive film/PU mesh film, to obtain the Kevlar fiber-woven composite sheet.

In some embodiments, the PU adhesive film/PU mesh film is produced by Jiangsu Dongrun Safety Technology Co., Ltd, China. In some embodiments, a mass ratio of the Kevlar fiber-woven fabric to the PU adhesive film/PU mesh film is in the range of (3-4): 1. In some embodiments, the hot pressing and compounding is conducted at a temperature of 120° C. to 135° C., the hot pressing and compounding is conducted at a pressure of 20 MPa to 40 MPa, and the hot pressing and compounding is conducted for 20 min to 60 min.

In some embodiments, the Kevlar fiber-woven composite sheet has an areal density of 200 g/m² to 350 g/m², preferably 250 g/m² to 300 g/m². In the present disclosure, backface signature of the bullet-proof and stab-proof material under the action of a tool puncture force or a bullet impact could be further improved by controlling the areal density of the Kevlar fiber-woven composite sheet within the above range, thereby further improving the bullet-proof and stab-proof effect.

In the present disclosure, the UHMWPE fiber-woven composite sheet is prepared by a process comprising:
(1) providing a UHMWPE fiber-woven fabric; and
(2) hot pressing and compounding the UHMWPE fiber-woven fabric obtained in step (1) with a PU adhesive film/PU mesh film, to obtain the UHMWPE fiber-woven composite sheet.

In the present disclosure, the UHMWPE fiber-woven fabric is provided. There are no special limitations on the operation for providing the UHMWPE fiber-woven fabric, and operations well known to those skilled in the art may be used.

In the present disclosure, the UHMWPE fiber-woven fabric is hot pressed and compounded with the PU adhesive film/PU mesh film, to obtain the UHMWPE fiber-woven composite sheet.

In some embodiments, the PU adhesive film/PU mesh film is produced by Jiangsu Dongrun Safety Technology Co., Ltd, China. In some embodiments, a mass ratio of the UHMWPE fiber-woven fabric to the PU adhesive film/PU mesh film is in the range of (3-4): 1. In some embodiments, the hot pressing and compounding is conducted at a temperature of 120° C. to 135° C., the hot pressing and compounding is conducted at a pressure of 20 MPa to 40 MPa, and the hot pressing and compounding is conducted for 20 min to 60 min.

In some embodiments, the UHMWPE fiber-woven composite sheet has an areal density of 150 g/m² to 300 g/m², preferably 200 g/m² to 250 g/m². In the present disclosure, backface signature of the bullet-proof and stab-proof material under the action of a tool puncture force or a bullet impact could be further improved by controlling the areal density of the UHMWPE fiber-woven composite sheet within the above range, thereby further improving the bullet-proof and stab-proof effect.

In some embodiments, the anti-backface signature layer has a thickness of less than or equal to 5 mm, preferably 0.3 mm to 0.4 mm. In the present disclosure, backface signature of the bullet-proof and stab-proof material under the action of a tool puncture force or a bullet impact could be further improved by controlling the thickness of the anti-backface signature layer within the above range, thereby further improving the bullet-proof and stab-proof effect.

In some embodiments, the impact-resistant layer accounts for 4.5% to 10%, preferably 5% to 8% of a mass of the bullet-proof and stab-proof material. In some embodiments, the cutting-resistant, bullet-proof and energy-absorbing layer accounts for 70% to 95.5%, preferably 75% to 90%, and more preferably 80% to 85% of the mass of the bullet-proof and stab-proof material. In some embodiments, the anti-backface signature layer accounts for 0% to 20%, preferably 1% to 15%, and more preferably 3% to 10% of the mass of the bullet-proof and stab-proof material. The bullet-proof and stab-proof effect of the bullet-proof and stab-proof material could be further improved by controlling the mass of each layer in the bullet-proof and stab-proof material within the above range.

In some embodiments, the Kevlar fiber, the UHMWPE fiber, the Kevlar fiber-woven fabric, and the UHMWPE fiber-woven fabric are subjected to a plasma treatment prior to being used, and then made into UD single sheets or woven composite sheets. In some embodiments, the plasma treatment is conducted at a voltage of 150 V to 200 V; and the plasma treatment is conducted for 60 seconds to 120 seconds. The plasma treatment could increase an anti-peeling strength of the fibers and the resins, which also indirectly helps to improve a bullet-proof property of the material.

The bullet-proof and stab-proof material includes an impact-resistant layer and a cutting-resistant, bullet-proof and energy-absorbing layer, where the impact-resistant layer is one or more Kevlar fiber-based UD sheets, which could resist initial cutting of a cutting tool and initial impact of shrapnel; the cutting-resistant, bullet-proof and energy-absorbing layer is formed by stacking a plurality of the Kevlar fiber-based UD sheets and/or a plurality of the UHMWPE fiber-based UD sheets, or by stacking a plurality of the Kevlar/UHMWPE hybrid fiber-based UD sheets. The Kevlar fiber and the UHMWPE fiber endow the bullet-proof and stab-proof material with cutting-resistant, bullet-proof and energy-absorbing functions, thereby further enhancing a bullet-proof and stab-proof effect.

In the present disclosure, the soft bullet-proof and stab-proof material also has a light weight, softness, and bullet-proof and stab-proof effect.

The technical solutions of the present disclosure will be clearly and completely described below with reference to the following examples, but they should not be construed as limiting the protection scope of the present disclosure.

### Example 1

A bullet-proof and stab-proof material consisted of an impact-resistant layer, a cutting-resistant, bullet-proof and energy-absorbing layer, and an anti-backface signature layer that were arranged in sequence from top to bottom.

The impact-resistant layer was a single Kevlar fiber-based UD sheet. The Kevlar fiber-based UD sheet was prepared by hot pressing and compounding eight layers of Kevlar fiber-based UD single sheets, in which two adjacent layers of the Kevlar fiber-based UD single sheets were arranged orthogonally. In the Kevlar fiber-based UD single sheet, a Kevlar fiber had a linear density of 600 D and a monofilament strength of 25 cN/dtex, and the Kevlar fiber-based UD single sheets each had an areal density of 50 g/m² and a thickness of 0.05 mm. The hot pressing and compounding was conducted at 120° C. and 20 MPa for 40 min. The Kevlar fiber-based UD sheet had an areal density of 400 g/m², and the impact-resistant layer had a thickness of 0.4 mm.

The cutting-resistant, bullet-proof and energy-absorbing layer was formed by stacking 22 Kevlar fiber-based UD sheets under the impact-resistant layer, followed by stacking 21 UHMWPE fiber-based UD sheets. The Kevlar fiber UD-based sheets each were prepared by hot pressing and compounding four layers of the Kevlar fiber-based UD single sheets, in which two adjacent layers of the Kevlar fiber-based UD single sheets were arranged orthogonally. In the Kevlar fiber-based UD single sheets, a Kevlar fiber had a linear density of 600 D and a monofilament strength of 25 cN/dtex, and the Kevlar fiber-based UD single sheets each had an areal density of 50 g/m² and a thickness of 0.05 mm. The hot pressing and compounding was conducted at 120° C. and 20 MPa for 40 min. The Kevlar fiber-based UD sheets each had an areal density of 200 g/m². The UHMWPE fiber-based UD sheets each were prepared by hot pressing and compounding four layers of the UHMWPE fiber-based UD single sheets. In the UHMWPE fiber-based UD single sheets, a UHMWPE fiber had a linear density of 400 D and a monofilament strength of 40 cN/dtex, and the UHMWPE fiber-based UD single sheets each had an areal density of 40 g/m². The hot pressing and compounding was conducted at 120° C. and 20 MPa for 40 min. The UHMWPE fiber-based UD sheets each had an areal density of 160 g/m².

The cutting-resistant, bullet-proof and energy-absorbing layer had a thickness of 8.6 mm and an areal density of 7,760 g/m².

The anti-backface signature layer was a single UHMWPE fiber-based UD sheet. The UHMWPE fiber-based UD sheet was prepared by hot pressing and compounding six layers of UHMWPE fiber-based UD single sheets. In the UHMWPE fiber-based UD single sheets, a UHMWPE fiber had a linear density of 400 D and a monofilament strength of 40 cN/dtex, and the UHMWPE fiber-based UD single sheets each had an areal density of 40 g/m². Two adjacent layers of the UHMWPE fiber-based UD single sheets were arranged orthogonally. The hot pressing and compounding was conducted at 120° C. and 20 MPa for 40 min. The UHMWPE fiber-based UD sheet had an areal density of 240 g/m². The anti-backface signature layer had a thickness of 0.3 mm.

The impact-resistant layer accounted for 4.76% of the mass of the bullet-proof and stab-proof material, the cutting-resistant, bullet-proof and energy-absorbing layer accounted for 92.38% of the mass of the bullet-proof and stab-proof material, and the anti-backface signature layer accounted for 2.86% of the mass of the bullet-proof and stab-proof material.

A performance test was conducted on the bullet-proof and stab-proof material of Example 1. The bullet-proof and stab-proof material has a total areal density of 8.4 kg/m², meeting bullet-proof requirements of GA Level 2 (average backface signature of less than or equal to 25 mm), GA Level 3 (average backface signature of less than or equal to 25 mm), NIJ Level IIA (average backface signature of less than or equal to 35 mm), NIJ Level II (average backface signature of less than or equal to 35 mm), and NIJ Level IIIA (average backface signature of less than or equal to 32 mm), and a stab-proof requirement of NIJ Level 2.

### Example 2

A bullet-proof and stab-proof material consisted of an impact-resistant layer and a cutting-resistant, bullet-proof and energy-absorbing layer that were arranged in sequence from top to bottom.

The impact-resistant layer was a single Kevlar fiber-based UD sheet. The Kevlar fiber-based UD sheet was prepared by hot pressing and compounding eight layers of Kevlar fiber-based UD single sheets, in which two adjacent layers of the Kevlar fiber-based UD single sheets were arranged orthogonally. In the Kevlar fiber-based UD single sheet, a Kevlar fiber had a linear density of 600 D and a monofilament strength of 25 cN/dtex, and the Kevlar fiber-based UD single sheets each had an areal density of 50 g/m² and a thickness of 0.05 mm. The hot pressing and compounding was conducted at 120° C. and 20 MPa for 40 min. The Kevlar fiber-based UD sheet had an areal density of 400 g/m², and the impact-resistant layer had a thickness of 0.4 mm.

The cutting-resistant, bullet-proof and energy-absorbing layer was formed by stacking 42 Kevlar/UHMWPE hybrid fiber-based UD sheets that were arranged orthogonally. The Kevlar/UHMWPE hybrid fiber-based UD sheets each were prepared by hot pressing and compounding four layers of hybrid fiber-based UD single sheets, in which two adjacent layers of the hybrid fiber-based UD single sheets were arranged orthogonally. The hybrid fiber-based UD single sheets each were prepared from a Kevlar fiber, a UHMWPE fiber, and waterborne polyurethane according to a forming method of a UD fabric, in which the Kevlar fiber and the UHMWPE fiber were alternately arranged at a mass ratio of 1:1, and a mass of the waterborne polyurethane was 20% of a mass of the hybrid fiber-based UD single sheet. The hot pressing and compounding was conducted at 120° C. and 20 MPa for 40 min. The Kevlar/UHMWPE hybrid fiber-based UD sheets each had an areal density of 190 g/m².

The cutting-resistant, bullet-proof and energy-absorbing layer had a thickness of 8.4 mm and an areal density of 7,980 g/m².

The impact-resistant layer accounted for 4.77% of the mass of the bullet-proof and stab-proof material, and the cutting-resistant, bullet-proof and energy-absorbing layer accounted for 95.23% of the mass of the bullet-proof and stab-proof material.

A performance test was conducted on the bullet-proof and stab-proof material of Example 2. The bullet-proof and stab-proof material has a total areal density of 8.38 kg/m², meeting bullet-proof requirements of GA Level 2 (average backface signature of less than or equal to 25 mm), GA Level 3 (average backface signature of less than or equal to 25 mm), NIJ Level IIA (average backface signature of less than or equal to 35 mm), NIJ Level II (average backface signature of less than or equal to 35 mm), and NIJ Level IIIA (average backface signature of less than or equal to 35 mm), and a stab-proof requirement of NIJ Level 2.

### Example 3

A bullet-proof and stab-proof material consisted of an impact-resistant layer, a cutting-resistant, bullet-proof and energy-absorbing layer, and an anti-backface signature layer that were arranged in sequence from top to bottom.

The impact-resistant layer was a single Kevlar fiber-based UD sheet. The Kevlar fiber-based UD sheet was prepared by hot pressing and compounding eight layers of Kevlar fiber-based UD single sheets, in which two adjacent layers of the Kevlar fiber-based UD single sheets were arranged orthogonally. In the Kevlar fiber-based UD single sheet, a Kevlar fiber had a linear density of 600 D and a monofilament strength of 25 cN/dtex, and the Kevlar fiber-based UD single sheets each had an areal density of 45 g/m² and a thickness of 0.05 mm. The hot pressing and compounding was conducted at 120° C. and 20 MPa for 40 min. The Kevlar fiber-based UD sheet had an areal density of 360 g/m², and the impact-resistant layer had a thickness of 0.4 mm.

The cutting-resistant, bullet-proof and energy-absorbing layer was formed by stacking 34 Kevlar fiber-based UD sheets that were arranged orthogonally. The Kevlar fiber-based UD sheets each were prepared by hot pressing and compounding six layers of the Kevlar fiber-based UD single sheets, in which two adjacent layers of the Kevlar fiber-based UD single sheets were arranged orthogonally. In the Kevlar fiber-based UD single sheets, a Kevlar fiber had a linear density of 400 D and a monofilament strength of 30 cN/dtex, and the Kevlar fiber-based UD single sheets each had an areal density of 35 g/m² and a thickness of 0.04 mm. The hot pressing and compounding was conducted at 120° C. and 20 MPa for 40 min. The Kevlar fiber-based UD sheet had an areal density of 210 g/m².

The cutting-resistant, bullet-proof and energy-absorbing layer had a thickness of 8.16 mm and an areal density of 7,140 g/m².

The anti-backface signature layer was a single Kevlar fiber-based UD sheet. The Kevlar fiber-based UD sheet was prepared by hot pressing and compounding eight layers of Kevlar fiber-based UD single sheets. In the Kevlar fiber-based UD single sheets, a Kevlar fiber had a linear density of 600 D and a monofilament strength of 25 cN/dtex, and the Kevlar fiber-based UD single sheets each had an areal density of 45 g/m². Two adjacent layers of the Kevlar fiber-based UD single sheets were arranged orthogonally. The hot pressing and compounding was conducted at 120° C. and 20 MPa for 40 min. The Kevlar fiber-based UD sheet had an areal density of 360 g/m². The anti-backface signature layer had a thickness of 0.4 mm.

The impact-resistant layer accounted for 4.58% of the mass of the bullet-proof and stab-proof material, the cutting-resistant, bullet-proof and energy-absorbing layer accounted for 90.84% of the mass of the bullet-proof and stab-proof material, and the anti-backface signature layer accounted for 4.58% of the mass of the bullet-proof and stab-proof material.

A performance test was conducted on the bullet-proof and stab-proof material of Example 3. The bullet-proof and stab-proof material has a total areal density of 7.86 kg/m², meeting bullet-proof requirements of GA Level 2 (average backface signature of less than or equal to 25 mm), GA Level 3 (average backface signature of less than or equal to 25 mm), NIJ Level IIA (average backface signature of less than or equal to 35 mm), NIJ Level II (average backface signature of less than or equal to 35 mm), and NIJ Level IIIA (average backface signature of less than or equal to 25 mm), and a stab-proof requirement of NIJ Level 2.

It can be seen from the above examples that the bullet-proof and stab-proof material provided by the present disclosure has excellent bullet-proof and stab-proof properties.

The above description of examples is merely provided to help illustrate the method of the present disclosure and a core idea thereof. It should be noted that several improvements and modifications may be made by those skilled in the art without departing from the principle of the present disclosure, and these improvements and modifications should also fall within the protection scope of the present disclosure. Various amendments to these embodiments are apparent to those skilled in the art, and the general principles defined herein may be implemented in other embodiments without departing from the spirit or scope of the present disclosure. Thus, the present disclosure is not limited to the examples shown herein but falls within the widest scope consistent with the principles and novel features disclosed herein.

1. A bullet-proof and stab-proof material, comprising an impact-resistant layer and a cutting-resistant, bullet-proof and energy-absorbing layer that are arranged in sequence, wherein
the impact-resistant layer is one or more Kevlar fiber-based unidirectional (UD) sheets;
the cutting-resistant, bullet-proof and energy-absorbing layer is formed by stacking a plurality of the Kevlar fiber-based UD sheets and/or a plurality of ultra-high-molecular-weight polyethylene (UHMWPE) fiber-based UD sheets, or by stacking a plurality of Kevlar/UHMWPE hybrid fiber-based UD sheets; and
each of the Kevlar/UHMWPE hybrid fiber-based UD sheets is prepared by a process comprising hot pressing and compounding a plurality of hybrid fiber-based UD single sheets, wherein each of the hybrid fiber-based UD single sheets is prepared from a Kevlar fiber, a UHMWPE fiber, and a thermoplastic resin according to a forming method of a UD fabric; or
each of the Kevlar/UHMWPE hybrid fiber-based UD sheets is prepared by a process comprising hot pressing and compounding a plurality of Kevlar fiber-based UD single sheets and a plurality of UHMWPE fiber-based UD single sheets that are alternately arranged.

2. The bullet-proof and stab-proof material of claim 1, further comprising an anti-backface signature layer stacked on a side of the cutting-resistant, bullet-proof and energy-absorbing layer opposite to the impact-resistant layer, wherein the anti-backface signature layer is one or more of the Kevlar fiber-based UD sheets, one or more of the UHMWPE fiber-based UD sheets, one or more Kevlar fiber-woven composite sheets, or one or more UHMWPE fiber-woven composite sheets.

3. The bullet-proof and stab-proof material of claim 2, wherein
the anti-backface signature layer is one or more of the Kevlar fiber-based UD sheets;
each of the Kevlar fiber-based UD sheets is prepared by a process comprising hot pressing and compounding six or eight layers of Kevlar fiber-based UD single sheets, wherein two adjacent Kevlar fiber-based UD single sheets are orthogonally arranged; and
each of the Kevlar fiber-based UD sheets has an areal density of 180 g/m² to 400 g/m².

4. The bullet-proof and stab-proof material of claim 2, wherein
the anti-backface signature layer is one or more of the UHMWPE fiber-based UD sheets;
each of the UHMWPE fiber-based UD sheets is prepared by a process comprising hot pressing and compounding six or eight UHMWPE fiber-based UD single sheets, wherein two adjacent UHMWPE fiber-based UD single sheets are orthogonally arranged; and
each of the UHMWPE fiber-based UD sheets has an areal density of 120 g/m² to 320 g/m².

5. The bullet-proof and stab-proof material of claim 2, wherein
the anti-backface signature layer is the one or more Kevlar fiber-woven composite sheets or the one or more UHMWPE fiber-woven composite sheets;
each of the Kevlar fiber-woven composite sheets has an areal density of 200 g/m² to 350 g/m²; and
each of the UHMWPE fiber-woven composite sheets has an areal density of 150 g/m² to 300 g/m².

6. The bullet-proof and stab-proof material of claim 2, wherein the anti-backface signature layer has a thickness of less than or equal to 5 mm.

7. The bullet-proof and stab-proof material of claim 1, wherein the impact-resistant layer comprises two to five of the Kevlar fiber-based UD sheets, and two adjacent Kevlar fiber-based UD sheets are orthogonally arranged.

8. The bullet-proof and stab-proof material of claim 1, wherein
in the impact-resistant layer, each of the Kevlar fiber-based UD sheets is prepared by a process comprising hot pressing and compounding six or eight Kevlar fiber-based UD single sheets, wherein two adjacent Kevlar fiber-based UD single sheets are orthogonally arranged; and
each of the Kevlar fiber-based UD sheets has an areal density of 180 g/m² to 400 g/m².

9. The bullet-proof and stab-proof material of claim 1, wherein the impact-resistant layer has a thickness of 0.5 mm to 2.5 mm.

10. The bullet-proof and stab-proof material of claim 1, wherein
the cutting-resistant, bullet-proof and energy-absorbing layer comprises the plurality of the Kevlar fiber-based UD sheets; and
each of the Kevlar fiber-based UD sheets is prepared by a process comprising hot pressing and compounding four to eight Kevlar fiber-based UD single sheets, and has an areal density of 120 g/m² to 200 g/m².

11. The bullet-proof and stab-proof material of claim 1, wherein
the cutting-resistant, bullet-proof and energy-absorbing layer comprises the plurality of the UHMWPE fiber-based UD sheets; and
each of the UHMWPE fiber-based UD sheets is prepared by a process comprising hot pressing and compounding four to eight UHMWPE fiber-based UD single sheet, and has an areal density of 80 g/m² to 160 g/m².

12. The bullet-proof and stab-proof material of claim 1, wherein the cutting-resistant, bullet-proof and energy-absorbing layer comprises 20 to 80 of the Kevlar/UHMWPE hybrid fiber-based UD sheets.

13. The bullet-proof and stab-proof material of claim 1, wherein
the cutting-resistant, bullet-proof and energy-absorbing layer comprises the plurality of the Kevlar/UHMWPE hybrid fiber-based UD sheets; and
each of the Kevlar/UHMWPE hybrid fiber-based UD sheets is prepared by a process comprising hot pressing and compounding four to eight of the hybrid fiber-based UD single sheets, and has an areal density of 100 g/m² to 180 g/m².

14. The bullet-proof and stab-proof material of claim 1, wherein
the cutting-resistant, bullet-proof and energy-absorbing layer comprises the plurality of the Kevlar/UHMWPE hybrid fiber-based UD sheets;
each of the Kevlar/UHMWPE hybrid fiber-based UD sheets is prepared by the process comprising hot pressing and compounding a plurality of hybrid fiber-based UD single sheets; and
in each of the hybrid fiber-based UD single sheets, a Kevlar fiber and a UHMWPE fiber are alternately arranged, and a mass ratio of the Kevlar fiber to the UHMWPE fiber is 1:1.

15. The bullet-proof and stab-proof material of claim 1, wherein
the cutting-resistant, bullet-proof and energy-absorbing layer comprises the plurality of the Kevlar/UHMWPE hybrid fiber-based UD sheets;
each of the Kevlar/UHMWPE hybrid fiber-based UD sheet is prepared by a process comprising hot pressing and compounding two to four Kevlar fiber-based UD single sheets and two to four UHMWPE fiber-based UD single sheets, wherein the two to four UHMWPE fiber-based UD single sheets are alternately arranged; and
each of the Kevlar/UHMWPE hybrid fiber-based UD sheet has an areal density of 100 g/m² to 180 g/m².

16. The bullet-proof and stab-proof material of claim 15, wherein the hot pressing and compounding is conducted at a temperature of 120° C. to 140° C. and a pressure of 20 MPa to 40 MPa for 20 min to 60 min.

17. The bullet-proof and stab-proof material of claim 1, wherein the cutting-resistant, bullet-proof and energy-absorbing layer has a thickness of 8 mm to 24.5 mm.

18. The bullet-proof and stab-proof material of claim 17, wherein the thickness of the cutting-resistant, bullet-proof and energy-absorbing layer is 8 mm to 20 mm.

19. The bullet-proof and stab-proof material of claim 7, wherein
each of the Kevlar fiber-based UD sheets is prepared by a process comprising hot pressing and compounding six or eight Kevlar fiber-based UD single sheets, wherein two adjacent Kevlar fiber-based UD single sheets are orthogonally arranged; and
each of the Kevlar fiber-based UD sheets has an areal density of 180 g/m² to 400 g/m².

20. The bullet-proof and stab-proof material of claim 12, wherein each of the Kevlar/UHMWPE hybrid fiber-based UD sheets is prepared by a process comprising hot pressing and compounding four to eight of the hybrid fiber-based UD single sheets, and has an areal density of 100 g/m² to 180 g/m².
